(19) United States
(12) Patent Application Publication
(10) Pub. No.: US 2015/0357687 A1
(43) Pub. Date: Dec. 10, 2015

(54) TEMPERATURE CONTROL DEVICE FOR CONTROLLING THE TEMPERATURE OF A BATTERY

(71) Applicant: Mahle International GmbH, Stuttgart (DE)

(72) Inventors: Oliver Heeg, Schwieberdingen (DE); Dominique Raible, Rottenburg (DE); Oleksandr Pavlov, Herrenberg (DE)

(21) Appl. No.: 14/730,324

(22) Filed: Jun. 4, 2015

(30) Foreign Application Priority Data
Jun. 4, 2014 (DE) 102014210572.2

(51) Int. Cl. H01M 10/625; H01M 10/65

(52) U.S. Cl. CPC H01M 10/625; H01M 10/65; H01M 2220/20

(57) ABSTRACT

A temperature control device for a battery may include at least one heat transmission element being flowable through by a fluid in a flow direction. The heat transmission element may include at least one effective area facing the battery. The at least one effective area may include at least one compensation layer composed of an elastic material disposed thereon. The at least one compensation layer may include at least two layer sections arranged at a distance from one another on the effective area along the transmission element.

### CROSS-REFERENCE TO RELATED APPLICATIONS

This application claims priority to German Patent Application No. 10 2014 210 572.2, filed Jun. 4, 2014, the contents of which are hereby incorporated by reference in its entirety.

### TECHNICAL FIELD

The invention relates to a temperature control device for controlling the temperature, in particular a cooling device for the cooling and/or a heating device for the heating, of a battery, and a battery arrangement with such a temperature control device. The invention also relates to a motor vehicle with such a battery arrangement.

### BACKGROUND

Rechargeable battery systems for electric vehicles with a purely electric drive and for hybrid vehicles and vehicles with fuel cell drive are the subject of current research. At present, in the said types of vehicle, lithium-ion batteries are preferably used, which are distinguished by a high energy density and an only slightly marked, undesired memory effect. The capability of a rechargeable battery to reliably supply various electric consumers installed in motor vehicles with electrical energy depends to a considerable extent on the thermal conditions prevailing in the environment of the battery. This is because both the electrochemical processes occurring in the battery in the provision and also in the receiving of electrical energy in the sense of recharging are dependent to a not insignificant extent on the operating temperature of the battery. Extensive investigations of various lithium-ion-based battery systems have shown, for instance, that below a critical temperature, for instance in the region of approximately 0° C., the electrical energy density made available by the battery decreases greatly compared with higher operating temperatures. Below this temperature, in addition damage to the Li-ion cell can occur during charging.

The provision of thermally well-defined environmental conditions is therefore crucial for a reliable and interference-free operation of said batteries—this applies not only for said lithium-ion-based batteries, but generally for any rechargeable battery systems. With regard to the considerable temperature fluctuations occurring under normal operating conditions for instance in a motor vehicle, this means that these must be compensated by suitable temperature control devices coupled thermally with the battery, in order to keep the environmental temperature of the battery—and hence also the temperature of the battery itself—within a temperature interval specified, for example, by the manufacturer.

Temperature control devices with heat exchangers are known from the prior art, for example cooling plates or collector/tube systems with fluid ducts which form a cooling channel, which is flowed through by a heat transmission medium, for example a coolant. The battery cells which are to be temperature-controlled are brought to lie respectively flat against a heat transmission element, for example a duct wall of the heat exchanger of the temperature control device. In this way, a thermal contact is produced between the battery and the coolant, so that the coolant can extract heat from the battery cells and their temperature can consequently be kept below a maximum permissible threshold value.

In such temperature control devices, it proves to be significant that both for the heat transmission elements, for example the fluid ducts, and also for the housing, a material with high thermal conductivity must be selected, if a highly effective thermal coupling is to be achieved between battery and heat transmission medium. Furthermore, however, frequently also a mechanical compensation must also be performed by the so-called interface material, in order to compensate manufacturing and installation tolerances in the cell module manufacture. If this compensation cannot take place, or can only take place partially, this leads to air inclusions in the region between cooler and cell module base, whereby a poor or respectively non-homogeneous cooling of the module takes place. It is, however, an essential task not only to maintain the specified temperature range, but also to keep the temperature differential between the cells of a battery as small as possible.

From DE 10 2008 059 952 B4 a battery with several battery cells and a generic temperature control device constructed as a cooling device for cooling the battery cells is known. A metallic base body of the temperature control device is equipped with an electrically insulating insulation layer. This is an injection moulded layer of a plastic injected onto the base body.

It is further known from the prior art to arrange thermally highly conductive materials with elastic characteristics between the individual battery cells and a heat exchanger, e.g. a cooling plate of the temperature control device, e.g. so-called heat-conducting foils. These are able partially to compensate the formation of undesired intermediate spaces between individual battery cells and the duct walls of the fluid duct, caused for instance owing to manufacturing- or installation tolerances. Heat-conducting foils, heat-conducting pastes or heat-conducting adhesives are used for use as a conventional thermal interface between the battery cells and the heat transmission element.

It proves to be a problem in the said heat-conducting pastes that their function in the practical operation of the temperature control device, typically in a motor vehicle, cannot be guaranteed for instance owing to regularly occurring vibrations. The mentioned heat-conducting foils, on the other hand, have the disadvantage that owing to their only limited elastic deformability they can only partially compensate variations in the dimensions of the intermediate spaces between the heat exchanger, e.g. cooling plate, and the individual battery cells according to permissible surface pressure.

It is therefore an object of the present invention to provide an improved embodiment for a temperature control device, in which the problems discussed above no longer occur.

The said problems are solved by the subject of the independent claims. Preferred embodiments are the subject of the dependent claims.

### SUMMARY

The basic idea of the invention is, accordingly, to provide in sections on a heat transmission element of the temperature control device an elastic, mechanical compensation layer, which has a low thermal resistance and is applied by means of screen printing and/or stencil printing. The application of a plastic onto the heat transmission element permits the formation of almost any desired print pattern by suitable selection of the print layout which is to be used. Thereby, it becomes possible to adapt the compensation layer e.g. to the geometry of the individual battery cells, whereby in turn an improved compression behaviour or respectively an improved elastic deformability of the compensation layer can be achieved. As a result, an improved thermal coupling of all battery cells to the heat transmission element can be achieved, and a low differential temperature of all cells of a battery can be ensured.

It is essential to the invention here that the effective area of the heat transmission element is not completely covered by said compensation layer, but rather that at least a region of the effective area of the heat transmission element exists in which no such layer is present. In other words, the compensation layer according to the invention comprises on the heat transmission element at least two layer sections arranged at a distance from one another. This permits the compensation layer, formed only in sections on the heat transmission element, to also extend laterally on the heat transmission element, when battery cells of the battery are arranged on the compensation layer. As a result, a particularly reliable mechanical and also thermal contact of the fluid flowing through the fluid duct to all battery cells arranged on the compensation layer is guaranteed, even when only a small surface pressure is permissible. This applies expressly also for those battery cells which due to manufacture or installation have a differing, increased distance from the effective area of the heat transmission element; this increased distance is completely filled by the plastic of the compensation layer which is applied by means of screen printing and/or stencil printing. Undesired intermediate spaces, because they reduce the thermal coupling between individual battery cells and the heat transmission element, are therefore avoided.

Furthermore, compared with conventional interface layers based on heat-conducting paste or a heat-conducting foil, on the basis of the compensation layer according to the invention, the same degree of thermal coupling with respect to the thermal homogeneity of the cells can already be achieved with reduced layer thickness, i.e. with reduced use of material. In addition, cost advantages occur, because the applying of a plastic by means of screen printing and/or stencil printing involves considerably reduced manufacturing costs compared with conventionally produced layers.

A temperature control device according to the invention for controlling the temperature of a battery has a fluid duct, able to be flowed through by a fluid, in particular by a coolant, which as heat transmission element in turn has at least one duct wall. On at least one effective area of the heat transmission element at least one elastic compensation layer of plastic, applied by means of screen printing and/or stencil printing, is provided. The compensation layer has at least two layer sections, which are arranged at a distance from one another on the outer side of the heat transmission element.

In a preferred embodiment, the plastic of the compensation layer is an elastomer. Elastomers are able to deform under compressive stress and tensile stress, which means that the layer formed from an elastomer, owing to its elastic characteristics, can adapt to varying distances between individual battery cells and the effective area of the heat transmission element. Therefore, it can be ensured that, if desired, each individual intermediate space between a particular battery cell and the heat transmission element is filled by the compensation layer. Silicone, rubber and polyurethane (PU) prove to be particularly suited to use as elastomer in the compensation layer. These basic substances can preferably have an increased thermal conductivity, which can be achieved by filling with suitable substances such as e.g. alu-oxide or copper. The material of the compensation layer can therefore be electrically insulating or electrically conductive, according to the requirements.

In another preferred embodiment, the compensation layer essential to the invention can have not only two, but a plurality of layer sections, which are all provided at a distance from one another on the heat transmission element. It is conceivable, for instance, that a separate layer section is associated with each of the battery cells of the battery which are to be cooled. The intermediate spaces formed between the individual layer sections then permit the individual layer sections to nestle against the battery cells, when the latter are pressed against the compensation layer in the course of their installation.

In an advantageous further development of the invention, the compensation layer, in a top view onto the heat transmission element, can have a plurality of layer sections with a respectively identical marginal contour. The resulting pattern-like construction of the compensation layer can be produced in a simple manner by means of the screen printing and/or stencil printing according to the invention by the use of a correspondingly configured screen or respectively a stencil. With suitable configuration of the geometry of the individual layer sections, these bring about a further improvement to the compression characteristics of the entire compensation layer.

Experimental investigations have shown that different distances between the different battery cells and the heat transmission element, which are not known beforehand on their installation on the heat transmission element, can be compensated particularly well when the layer section has in top view with the marginal contour of a polygon, preferably a quadrilateral, a hexagon, most preferably a rectangle or a regular hexagon.

In an advantageous further development, said layer sections are arranged in top view in a grid-like manner with at least two grid lines and at least two grid gaps on the effective area of the heat transmission element. In the intermediate spaces formed between the individual layer sections of the grid, no compensation layer is provided on the heat transmission element.

If, in addition, an electrical insulation is necessary, the partial layer essential to the invention can be applied onto an already present covering electrical insulation layer.

In a particularly preferred embodiment, it is proposed to dimension a first distance between two adjacent grid lines to be greater than a second distance between two adjacent grid gaps or vice versa. Such a geometry proves to be particularly advantageous when an individual battery cell extends along a grid line. The possibility presents itself to select the distance of two adjacent layer sections along a grid line to be smaller than along a grid gap, i.e. between two adjacent grid lines, so that the forming intermediate space is available as a compensation space for a lateral extending of the compensation layer along the grid line, when the respective battery cell is brought to abut against the compensation layer in the course of installation. In the optimum case, the intermediate spaces under a cell are completely closed in the course of tensioning. Reverse considerations apply when a battery cell is to be placed along a grid gap on the compensation layer.

For example, the first distance can be at least ten times, preferably twenty times the second distance, or vice versa. In such an embodiment, the first distance can be at least 0.4 mm and the second distance can be at most 8 mm, or vice versa.

In another preferred embodiment, the compensation layer can comprise at least two layers, preferably a plurality of layers, which are stacked on one another along a stacking direction. Said stacking direction is established here by the plane defined by the heat transmission element and runs orthogonally to this wall plane. The individual layers can be produced from respectively different plastics and/or can have individual layer thicknesses. It is also conceivable that the compensation layer on different sections of the heat transmission element is formed by a different number of individual layers. In this way, the elastic characteristics and therefore the compression behaviour of the compensation layer can be adapted to different requirements in a manner specific to the application.

In a further preferred embodiment, at least two layer sections of the compensation layer can have a different layer thickness. It is conceivable, for instance, to reduce the layer thickness in those regions in which the battery cells are to be brought to abutment against the heat transmission element or respectively compensation layer. This leads to an improved contact behaviour of the compensation layer. It is likewise conceivable to increase the partial coating in these regions, in order to also contact offset cells with an increased distance from the heat transmission element in every case and therefore to avoid thermally insulating air inclusions.

An embodiment proves to be particularly expedient, in which the at least two layer sections have a layer thickness between 100 and 2000 μm, depending on the cell offset which is to be compensated and the permissible surface pressure on tensioning.

The fluid duct can preferably be constructed as a flat tube, wherein the heat transmission element, equipped with the compensation layer according to the invention, forms a part of such a flat tube. Likewise, a so-called cover plate can additionally be applied onto the flat tube(s), which cover plate then constitutes the heat transmission element.

Further important features and advantages of the invention will emerge from the subclaims, from the drawings and from the associated figure description with the aid of the drawings.

It shall be understood that the features mentioned above and to be further explained below are able to be used not only in the respectively indicated combination, but also in other combinations or in isolation, without departing from the scope of the present invention.

### BRIEF DESCRIPTION OF THE DRAWINGS

Preferred example embodiments of the invention are represented in the drawings and are explained in further detail in the following description, wherein the same reference numbers refer to identical or similar or functionally identical components.

There are shown, respectively diagrammatically

FIG. 1 an example of a temperature control device according to the invention in a rough diagrammatic and partial illustration in a longitudinal section,

FIG. 2 the example of FIG. 1 in a top view onto the heat transmission element,

FIG. 3 a variant of the example of FIG. 2, in which the individual layer sections have the shape of rectangles,

FIG. 4A a variant of the example of FIG. 2, in which the individual layer sections have the shape of regular hexagons,

FIG. 4B the example of FIG. 4A in a longitudinal section with varying layer thickness of the compensation layer,

FIG. 5 a variant of the example of FIGS. 4A/4B, in which the number of individual layers varies within a layer section.

### DETAILED DESCRIPTION

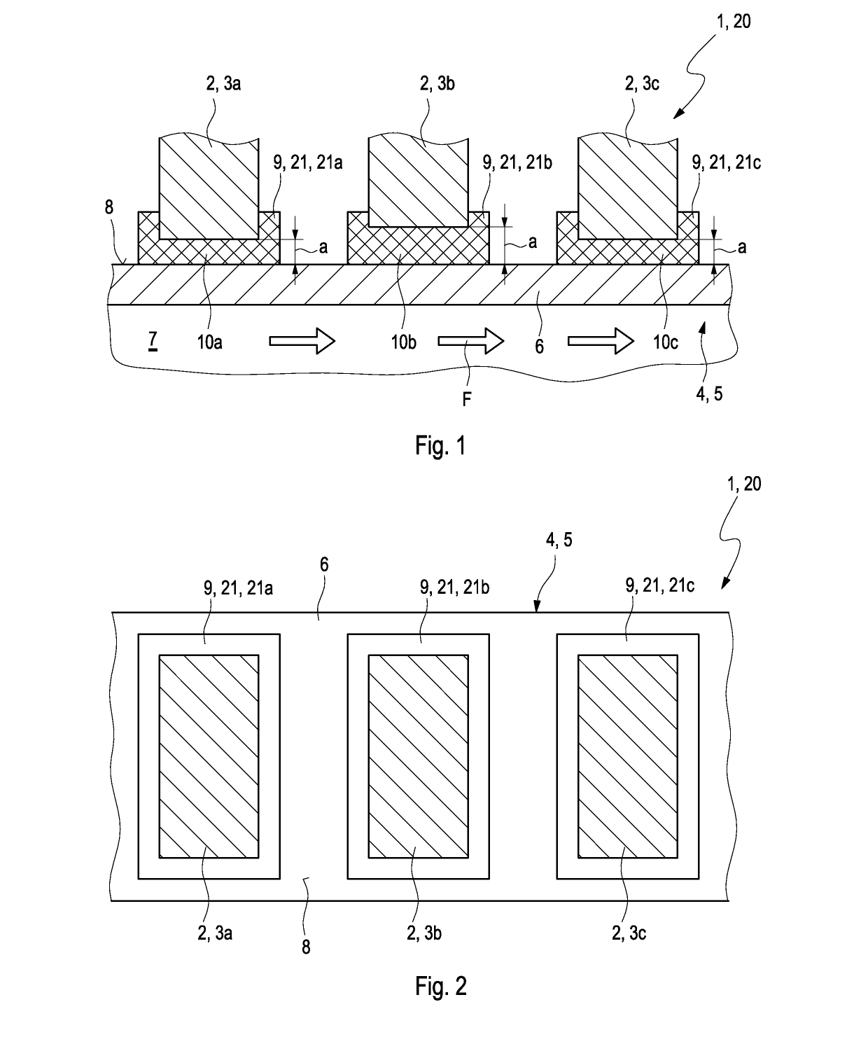

FIG. 1 illustrates in a rough diagrammatic schematic illustration and in a partial longitudinal section an example of a temperature control device 1 according to the invention for cooling a battery 2. The battery 2 has a plurality of battery cells, of which in the example scenario by way of example three battery cells 3a-3c are shown. A heat exchanger 4 forming the temperature control device 1, which is flowed though by a fluid F serving as coolant, comprises a heat transmission element 5, constructed for example as a fluid duct 6, of which in FIG. 1 for the sake of clarity only a single duct wall is illustrated. The heat transmission element 5 delimits a fluid duct 7, in which the fluid F can flow. By thermal interaction of the battery cells 3a-3c with the fluid F through the heat transmission element 5, these can deliver waste heat to the fluid F, which involves a cooling of the battery cells 3a-3c. For this, the battery cells 3a-3c are arranged on an effective area 8 of the heat transmission element 5. Particularly expediently, the fluid duct can be constructed here as a flat tube, wherein the transmission element 5, coated with the compensation layer 9 according to the invention, then forms a part of such a flat tube.

As FIG. 1 shows, a compensation layer 9 of a plastic is applied by means of screen printing and/or stencil printing on an effective area 8 of the heat transmission element 5 facing away from the fluid duct 7. The battery cells 3a-3c are mounted on this compensation layer 9 of the temperature control device 1. After completed mounting of the battery cells 3a-3c which are to be cooled, the compensation layer 9 is arranged in a sandwich-like manner between the heat transmission element 5 and the battery cells 3a-3c. The temperature control device 1 and the battery cells 3a-3c arranged on the compensation layer 9 form a battery arrangement 20.

From the illustration of FIG. 1 and of FIG. 2, which shows the arrangement of FIG. 1 in a top view onto the heat transmission element 5, constructed as fluid duct 6, it can be seen that the heat transmission element 5 is not completely covered by the compensation layer 9; rather, the compensation layer comprises a plurality of layer sections 21 arranged at a distance from one another. The use of a screen printing and/or stencil printing process for applying the compensation layer 9 on the heat transmission element 5 enables the production of the compensation layer 9 with almost any desired number of layer sections 21 spaced apart from one another. In the example scenario of FIG. 1, these are arranged only in the regions on the heat transmission element 5 in which a respective battery cell 3a-3c of the battery 2 is to be brought into abutment mechanically on the heat transmission element 5. For this, a respective layer section 21 of the compensation layer 9 serves as mechanical and thermal interface. Consequently, in FIG. 2 three layer sections 21a, 21b and 21c can be seen, which are respectively in contact mechanically with a respective battery cell 3a-3c.

The plastic of the compensation layer 9 is preferably an elastomer. Suitable elastomers are, for example, silicone or polyurethane (PU). To reduce the thermal resistance, these materials preferably have an increased thermal conductivity, which can be achieved for example by mixing/filling with readily thermally conductive materials. Owing to the spring-elastic characteristics of elastomers, the compensation layer 9 can be adapted to varying distances between the individual battery cells 3a-3c and the effective area 8 of the heat transmission element 5. Such varying distances can occur owing to installation or can be brought about by tolerances in the outer dimensions of individual battery cells. This is shown in FIG. 1 by way of example by means of the central battery cell 3b, the distance a of which to the heat transmission element 5 is greater than the distance a of the two adjacent battery cells 3a, 3d. By means of the compensation layer 9, it is ensured that each individual intermediate space 10a-10c between the respective battery cell 3a-3c and the heat transmission element 5 is filled by the compensation layer 9. As a result, this provides for the desired thermal coupling of all battery cells 3a-3c, in particular of the central battery cell 3b with increased distance a, with the heat transmission element 5. This would not exist for the central battery cell 3b or would only exist to a greatly reduced extent, if after the mounting of the battery cells 3a-3c between the battery cell 3b and the heat transmission element 5 a cavity remained between the layer section 21b and the battery cell 3b.

The use of a screen printing and/or stencil printing process for the production of the compensation layer 9 also makes it possible to produce this with a plurality of layer sections 16, which with respect to a top view onto the heat transmission element 5 have a respectively identical marginal contour 17, but alternatively also may have different marginal contours 17.

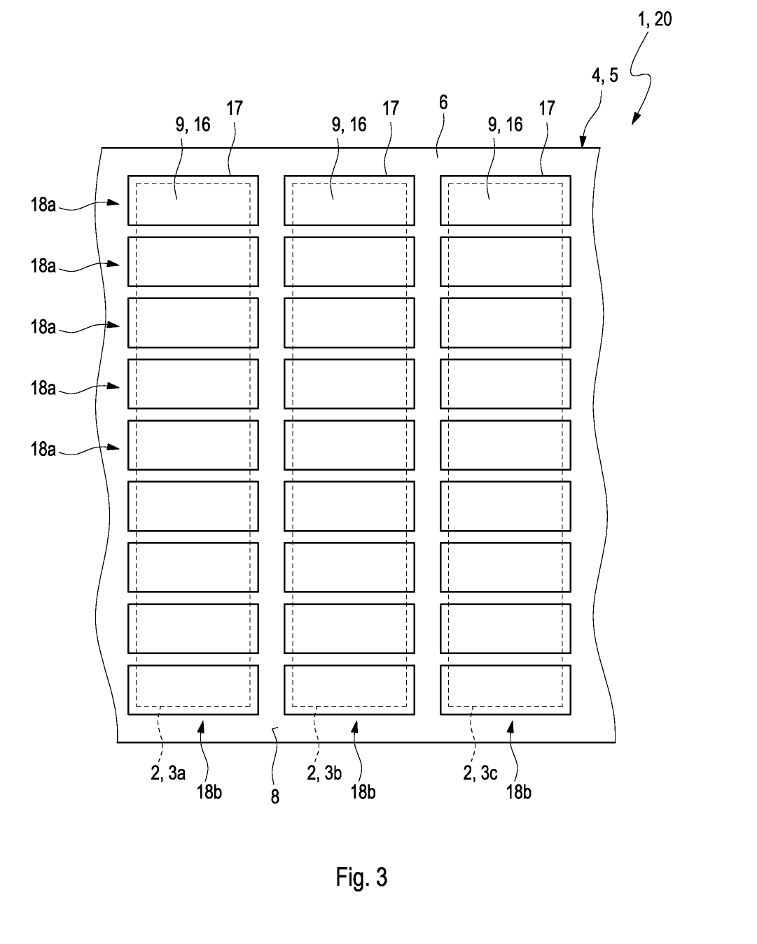

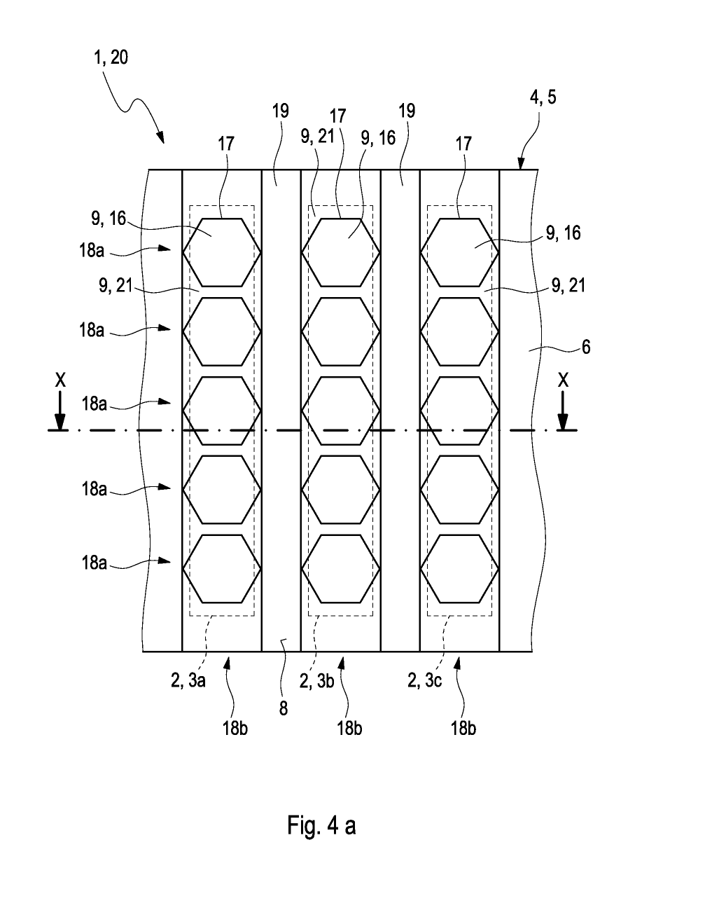

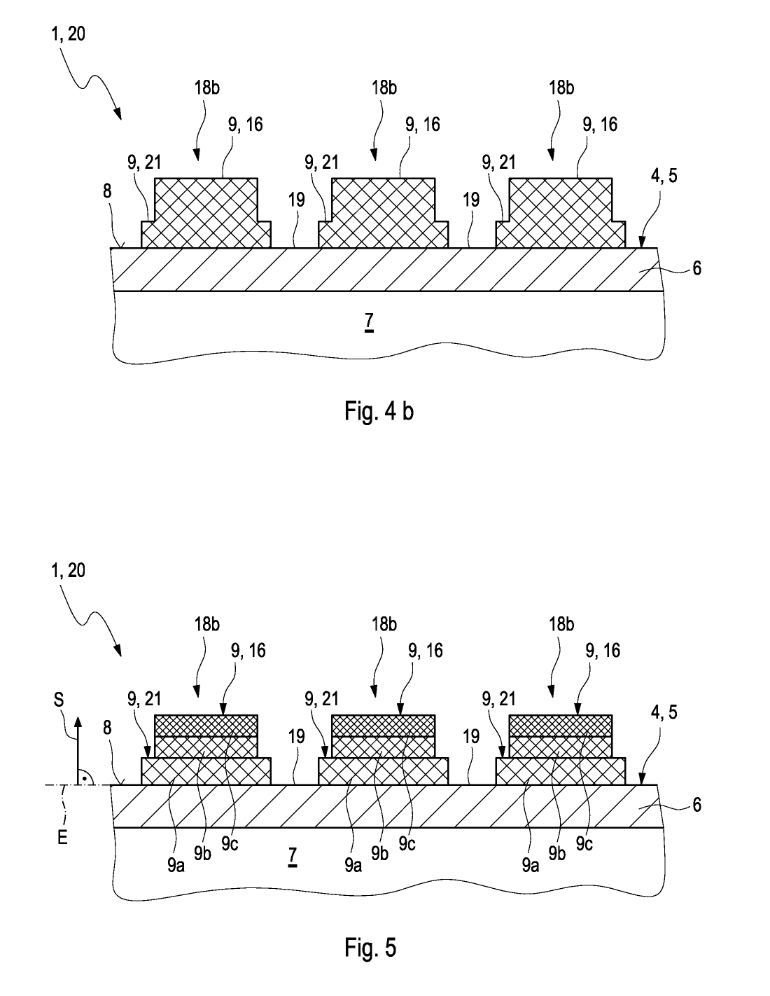

Examples of a pattern-like construction of the compensation layer resulting therefrom are illustrated by the examples of FIGS. 3 and 4. Particularly advantageous elastic characteristics of the compensation layer 9 result when the previously discussed layer sections 16 with respectively identical marginal contour 17 in top view are provided in a grid-like manner with at least two grid lines 18a and at least two grid gaps 18b on the effective area 8 of the heat transmission element 5.

Such a scenario is shown by the battery arrangement 20 of FIG. 3, according to which the individual layer sections 16 have respectively the marginal contour 17 of a rectangle and are arranged in a grid-like manner with respect to one another. Experimental investigations have shown that different distances between individual battery cells 3a-3c and the heat transmission element 5, which are not known at the mounting of the battery cells on the compensation layer 9, can be compensated particularly well by the compensation layer 9 when the layer sections 16 have in top view with the marginal contour of a polygon, preferably a quadrilateral or a hexagon, most preferably a rectangle or a hexagon. Instead of a rectangle, other configurations are also possible in variants of the example, for instance that of a square, a circle or an ellipse. Combinations of the said marginal contour are also conceivable.

As FIG. 3 clearly demonstrates, a battery cell 3a-3c (shown in dashed representation in FIG. 3) can be arranged respectively on each grid gap 18b of the grid. The number of layer sections 16 shown in FIG. 3 can, of course, vary in variants of the example. A first distance between two adjacent grid gaps 18b can, as shown, be greater here than a second distance between two adjacent grid lines 18a. It is conceivable in particular that the first distance is at least ten times, preferably twenty times the second distance or vice versa. For example, values for the first distance are at least 0.4 mm and the second distance at most 8 mm or vice versa.

The desired marginal contours 17 of the layer sections 16 can be produced by the layer sections 16 forming the marginal contour 17 of a polygon being equipped with an increased or reduced layer thickness compared with the remaining regions of the compensation layer 9. Alternatively or additionally, the layer sections 16 can also be realized by one or more additional individual layers of the compensation layer 9 with respect to the remaining regions of the compensation layer 9.

FIG. 4a shows a variant of the example of FIG. 3, in which the marginal contours 17 of the layer sections 16 respectively have the shape of a regular hexagon. In the example of FIG. 4, just as in the example according to FIG. 3, the distance between two adjacent grid gaps 18b is greater than that between two adjacent grid lines 18a. As illustrated in FIG. 4a, on the effective area 8 of the heat transmission element 5 between two adjacent grid gaps 18b, 18b or respectively two adjacent grid lines 18a, 18a, channel-like intermediate spaces 19 are respectively formed, in which no compensation layer 9 is provided. In regions 21 between the layer sections 16 with hexagonal marginal contour 17 and the intermediate spaces 19 without compensation layer 9, the layer thickness of the compensation layer 9 is reduced. This is demonstrated by the illustration of FIG. 4b, which shows the compensation layer 9 in a longitudinal section along the section line X-X of FIG. 4a.

In a variant of the example of FIGS. 4a and 4b illustrated in FIG. 5, which just as FIG. 4b shows a longitudinal section along the section line X-X of FIG. 4a, the hexagonal layer sections 16 of the compensation layer 9 comprise three individual layers 9a, 9b, 9c of a respectively different layer material, the regions 21 between the layer sections 16 and the intermediate spaces 19, on the other hand, having only the individual layer 9a. The three individual layers 9a, 9b, 9c forming the layer sections 16 are stacked on one another along a stacking direction S, wherein the stacking direction S runs orthogonally to a plane defined by the heat transmission element 5. By means of such a construction of the compensation layer 9 with a varying number of individual layers 9a, 9b, 9c, an improved thermal contact can be achieved between the heat transmission element and the battery cells.

1. A temperature control device for a battery, comprising:
at least one heat transmission element being flowable through by a fluid in a flow direction,
wherein the heat transmission element includes at least one effective area facing the battery, the at least one effective area including at least one compensation layer composed of an elastic material disposed thereon, and wherein the at least one compensation layer includes at least two layer sections arranged at a distance from one another on the effective area along the heat transmission element.

2. The temperature control device according to claim 1, wherein the elastic material of the compensation layer is a plastic.

3. The temperature control device according to claim 2, wherein the plastic comprises at least one of mixing and filling materials, so that it has an to promote thermal conductivity.

4. The temperature control device according to claim 1, wherein the at least two layer sections are arranged along the heat transmission element and only partially cover the effective area of the heat transmission element.

5. The temperature control device according to claim 1, wherein the compensation layer with respect to an elevated view onto the heat transmission element includes a plurality of layer sections arranged spaced from one another at least one of along the flow direction and transverse to the flow direction.

6. The temperature control device according to claim 1, wherein the at least two layer sections are respectively profiled to define an identical marginal contour with respect to an elevated view onto the compensation layer.

7. The temperature control device according to claim 5, wherein the plurality of layer sections define a geometry of a polygon with respect to the elevated view onto the heat transmission element.

8. The temperature control device according to claim 5, wherein the plurality of layer sections with respect to the elevated view are arranged in a grid-like arrangement on the effective area, wherein the grid-like arrangement defines at least two grid lines and at least two grid gaps extending transversely to the at least two grid lines.

9. The temperature control device according to claim 8, wherein a first distance between two adjacent grid lines is greater than a second distance between two adjacent grid gaps, or vice versa.

10. The temperature control device according to claim 9, wherein the first distance is at least ten times greater than the second distance, or vice versa.

11. The temperature control device according to claim 9, wherein the first distance is at least 0.4 mm and the second distance at most 8 mm, or vice versa.

12. The temperature control device according to claim 1, wherein the compensation layer further includes at least two individual layers arranged stacked on one another on the effective area of the heat transmission element along a stacking direction, which runs orthogonally to a plane defined by the heat transmission element.

13. The temperature control device according to claim 1, wherein the at least two layer sections have a different layer thickness in relation to one another.

14. The temperature control device according to claim 1, wherein the at least two layer sections have a layer thickness between 100 μm and 2000 μm.

15. The temperature control device according to claim 1, wherein the heat transmission element defines at least one fluid duct, and wherein the heat transmission element forms a part of the fluid duct.

16. (canceled)

17. A battery arrangement, comprising:
a temperature control device including at least one heat transmission element flowable through by a fluid flow, the heat transmission element including at least one effective area facing away from the fluid flow and at least one elastic compensation layer disposed on the at least one effective area, wherein the at least one compensation layer includes at least two layer sections arranged at a distance from one another along the effective area of the heat transmission element; and
at least one battery arranged on the heat transmission element and including at least one battery cell, wherein the compensation layer is arranged in a sandwich-like arrangement between the heat transmission element and the at least one battery cell.

18. The battery arrangement according to claim 17, wherein the at least two layer sections of the compensation layer respectively are disposed on the heat transmission element only in a region in which the at least one battery cell is arranged on the heat transmission element.

19. The battery arrangement according to claim 17 or 18, wherein the compensation layer further includes a plurality of individual layers stacked on one another along a stacking direction, which runs orthogonally to a plane defined by the heat transmission element, and wherein a number of the plurality of individual layers in a regions of the at least one battery cell, is at least one of greater and smaller than a region spaced away from the at least one battery cell.

20. The battery arrangement according to claim 17, wherein the compensation layer includes a layer thickness in a region of the at least one battery cell that is at least one of greater and smaller than a layer thickness of the compensation layer in a region spaced away from the at least one battery cell.

21. (canceled)

22. A method for producing a temperature control device, comprising the following steps:
applying at least two layer sections of a compensation layer composed of elastic material on at least one effective area of a heat transmission element via at least one of a screen printing process and a stencil printing process, wherein the at least two layer sections are arranged at a distance from one another on the at least one effective area and
arranging a battery including at least one battery cell on the compensation layer.
